(19) United States
(12) Patent Application Publication
(10) Pub. No.: US 2021/0090164 A1
(43) Pub. Date: Mar. 25, 2021

(54) BUSINESS TO BUSINESS CREDIT FACILITY PROVISIONING AND PROCESSING SYSTEM WITH AUTOMATIC LIGHTWEIGHT MODULE AS A PAYMENT OPTION AT CHECKOUT

(71) Applicant: JOHN TOMICH, LOS ANGELES, CA (US)

(72) Inventor: JOHN TOMICH, LOS ANGELES, CA (US)

(21) Appl. No.: 16/578,262

(22) Filed: Sep. 20, 2019

(51) Int. Cl. G06Q 40/02; G06Q 20/38

(52) U.S. Cl. CPC G06Q 40/025; G06Q 20/382

(57) ABSTRACT

Technologies are described herein for providing an internet connected computer system for improved business to business lending experience. Through the use of a simplified underwriting architecture, and a minimalistic user interface, the system improves the quality of the lending experience while reducing merchant risk and allowing product flexibility. The system further describes a secure environment, providing additional advantages over traditional methods of business to business underwriting.

### BACKGROUND OF THE INVENTION

Business-to-business (“B2B”) is a specific part of commerce that focuses on selling products and services to other companies, in contrast with the model of Business-to-consumer (“B2C”), whereby businesses sell products or services to consumers. B2B lending is comprised of four factors, which are: customer experience; privacy and security; product flexibility; and merchant risk.

The customer experience requires speed and ease of use in order to increase conversion rates. Current platforms require a lengthy form fill process with dozens of form fields to complete, and require sensitive personal information such as customer bank account login credentials, a full Social Security Number (“SSN”), driver's license number, and recent tax returns. Many current platforms also slow down potential transactions by requiring the submission of trade reference checks from the customer, such as consumer evidence of financial strain or changes in the customer buying pattern. Current platforms have limited lending flexibility, with limited options to choose the terms of paying back the loan, and not offering the customer choices on those terms. Current platforms do not offer overall line of credit options to the customer and have no ability to control the underwriting process, negatively impacting customer approval rates.

Current platforms expose the merchant to criminal penalties due to state usury laws. For example, if the customer is charged repayment late fees, this can be re-characterized as interest. If this interest, on an annualized basis, is greater than 25% in NY or 20% in MA, for example, this is a Class C felony, with 3.5 to 15 year sentences. If it's greater than 8% or 12% annualized in CA or TX respectively, this breaches state usury laws. There are dozens of states with ever-changing and complicated usury laws. Operating in potential breach of state usury laws carries significant risks. The merchant is also potentially exposed to state civil penalties if the lender does not have a bank sponsor or federally-chartered bank sponsor. What is needed is an optimization of these four factors.

There are approximately 29 million small and medium-sized businesses (“SMBs”) in the United States, which employ 50 million people, that are an integral part of the US economy. These businesses rely on the efficient access to outside capital to function and grow. According to the Federal Reserve, there were $157.9 billion in value in outstanding microloans (loans less than $100,000) in the United States as of 2Q 2016. Historically, businesses looking for a source of third-party working capital or microloans would approach a local, regional or national bank. Many of these institutions have essentially abandoned the small business market over the last decade for various reasons, including high fixed costs and outdated technology that prohibits efficient and cost-effective underwriting.

Additionally, at any given time, these SMBs in aggregate hold hundreds of billions over in outstanding trade credit payable balances, which is essentially a supplier providing them short term “capital” to facilitate a business purchase. For decades, business-to-business (“B2B”) merchants have extended trade credit to these SMB customers, allowing them to buy now, and pay in 30, 60 or 90 days. One of the structural challenges with trade credit in the e-commerce age is that merchants oftentimes will offer too little credit to too few customers, as well as take days or weeks to do underwriting. The trade credit industry is ripe for product innovation and disruption.

SMBs need goods to run their businesses, whether it's an HVAC installer buying maintenance supplies, a t-shirt shop buying blank t-shirts for printing, or a mom & pop computer supplier purchasing hard drives for resale. Much like consumer purchases, these B2B sales are increasingly moving online, with telephone and in-store sales quickly being outpaced by purchases through e-commerce websites. B2B e-commerce volume is currently double the size of B2C e-commerce, and is projected to surpass $1 T in gross merchandise value (“GMV”) by 2020. Despite the large GMV number, B2B e-commerce technology sophistication and penetration lags a decade or so behind B2C. In multiple surveys, B2B e-commerce users list flexible payment options as one of the most desired areas for improvement and innovation.

### SUMMARY OF THE INVENTION

According to one embodiment of the present invention, the user installs a lightweight module on the user's e-commerce payment portal that presents the invention as a payment option at checkout. This module of the present invention allows for real time underwriting through a proprietary scoring method. Through the use of a few additional details, the customer is able to be verified and approved online within seconds. The customer completes the transaction online, and the order is confirmed.

The system and method of the present invention are beneficial to merchants by providing increased revenue; an improved consumer experience (“CX”); simple integration into the merchant's e-commerce platform; lower cost and risk due to improved verification; and an overall increase in cash flow. The present invention benefits business borrowers by providing instant, simple approval; increased credit amounts and larger lines of credit; better credit rates; longer repayment terms; and customer support.

The present invention provides several advantages to the merchant, including but not limited to better differentiation against competitors; driving higher purchasing on existing member accounts; and increasing sales by providing flexible pay-over-time solutions to the customer.

One embodiment of the present invention is the integration of cloud software tools with capital and bank partnerships to build an enhanced system of risk screening, loan servicing and regulatory compliance. The present invention is partnered with a Utah chartered industrial bank to ensure compliance with FDIC and state regulations.

The present invention helps merchants deliver payment flexibility to customers through methods such as but not limited to: purchase funnel financing; post-decline financing; and addressing the issues of cart abandonment and post-decline emails through consumer alerts and reminders.

One embodiment of the present invention is that it creates a more streamlined process for B2B lending. The customer experience is improved upon as the present invention allows for fast in-cart approvals within 5 seconds and requires less time and consumer data to complete, allowing for higher conversion rates. The present invention offers improved privacy and security, whereby personal details such as a customer's tax statements, or driver's license number are not required in the approval process, and trade reference checks are not needed. The present invention is a true pay-over-time product, instead of the typical single option net term replacement. This flexibility drives higher conversion rates, Average Order Value (“AOV”), and order volume. The underwriting is controlled by the present invention in order to lend most effectively and have the ability to control approval rates. The present invention includes Utah chartered bank sponsorship to eliminate merchant exposure to civil state penalties, and criminal penalties due to state usury laws.

The present invention does not have a line of credit which is open ended but rather a trade credit limit.

The present invention utilizes a unique method of mixing Enterprise Resource Planning (“ERP)” data with data from Public Credit Bureaus (TransUnion, Equifax & Experian (FICO)). ERP data is derived from: the service provider or retailer etc.; from its client; Social Security number or a portion; spending; and payment history data which service or product supplier gathers from the party wishing to have credit extended to it. The present invention features a lightweight approach, allowing for integration into a merchant's database. Merchants have ERP data derived from their respective customer relationships.

The present invention provides a valuable service to its Merchant partners on two fronts. For Merchants that offer net trade credit to its customers, the present invention provides an alternative solution so that it no longer has to do so. For a Merchant to effectively extend trade credit it needs to have: (i) the ability to assess the creditworthiness of its customers to determine if they are eligible for trade credit and to determine how much trade credit they will offer, (ii) be willing to wait the term of the trade credit to receive its funds, many times without monetary compensation, (iii) have a collections/servicing department to make sure payments are received, and (iv) be willing to accept the risk that the customer will not pay. All of the above capabilities have a cost associated with them. By integrating with the present invention, these Merchants will no longer have to execute the above tasks and focus on their core business. Since the present invention is integrated with a finance company, it will be able to better assess customer creditworthiness which will translate into more customers approved for trade credit and larger credit amounts extended. The present invention will also eliminate the need for the Merchant to have a staff dedicated to managing trade credit and servicing the account receivables. The Merchant will also eliminate all of the risk associated with the customer not paying and receive the funds two days after the transaction versus having to wait thirty days.

The above factors translate into material costs savings and risk reduction for the Merchants. For Merchants that don't extend trade credit, the present invention provides an alternative payment option that will provide flexibility to customers. This flexibility will allow customers to better manage their cash flow which will translate into higher order sizes and increased revenue for the Merchant and higher satisfaction rates for the customers.

By providing more trade credit to more customers and allowing payment flexibility, the present invention will be increasing customer's average order size and increasing revenues for the Merchants. By taking on the trade credit function of the Merchants, the present invention will also reduce risk and costs to the Merchants while improving their cash flow. For all of these benefits the Merchant will pay a processing fee to the financing company associated with the present invention starting at 2.9% of the transaction amount which will decline base on volume thresholds. This fee is priced similarly to credit card processing fees that the Merchant would have otherwise paid to execute the transactions.

The present invention offers SMB customers a new payment solution, that results in better access to credit, in seconds, right at the e-commerce point of purchase. SMB customers enter a few details about the business owner (name, address, social security number, date of birth, etc.) and the business (name, employer identification number, address, etc.), and the present invention is instantly able to approve and fund the order, right at e-commerce checkout. The present invention does this through a real-time, proprietary scoring engine that delivers a high approval rate, and interest rates that are often lower than the SMB customer's credit cards. In just a few clicks, SMB owners are able to use a flexible B2B payment option that lets them pay over time for their orders. The present invention makes business credit transactional.

The present invention has multiple advantages built into its business model. Other business lending options (OnDeck, Kabbage, etc.) have to charge high interest rates/ fees due to the fact that the use of the funds they provide SMB customers is undetermined. The SMB recipient might use the funds for business purposes, or they might be used for non-business purposes, like a personal vacation. The present invention funds the B2B merchant directly, not the SMB, so the loan is always guaranteed to be for a business use.

The present invention also enjoys access directly to its merchant partners' historical transaction data, which provides a powerful underwriting decision advantage. At scale, along with the present invention's own transactional data, this will make the present invention's proprietary scoring incredibly robust and valuable.

Another distinct advantage is that once the present invention is integrated as a payment option on a merchant's site, there's no incremental cost for new users. This provides substantial and unique economies of scale.

The present invention's team has deep e-commerce and product experience, with multiple successful exits among the founding team. The key principle that drives all of the present invention's product offerings is customer experience. On this front, the present invention is truly transformative.

Applying for a loan has never been described as a simple or speedy process, but the present invention aims to invert that perception. By pulling personal and business information from the cart, the present invention pre-populates form fields, making the process easier for the user. With a clean UI and as little data entry as possible, the present invention accelerates the SMB customer to a transaction, helping both customers and merchants succeed.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 is a diagram showing the data used to obtain the credit score for the present invention.

FIG. 2 is a diagram showing the underwriting process of the present invention.

FIGS. 3A-B are diagrams of the admin portal of the present invention.

FIG. 4 Is a process flow diagram of the known borrower underwriting model of the present invention.

FIGS. 5A-C are diagrams of the borrower portal of the present invention.

FIGS. 6A-K are diagrams showing the pre-approval flow of the present invention.

FIG. 7 is a flow diagram showing one aspect of the present invention.

### DETAILED DESCRIPTION OF THE PREFERRED EMBODIMENT

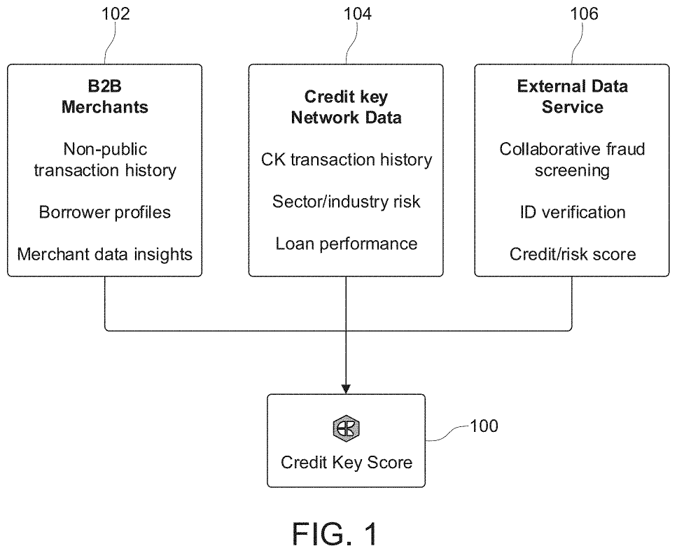

FIG. 1 is a diagram showing the data used to obtain the credit score for the present invention. In accordance with the preferred embodiment of the present invention, the process of obtaining a credit score 100 requires data from B2B Merchants 102, credit network data 104, and external data services 106. Data from B2B Merchants 102 includes non-public transaction history; borrower profiles; and merchant data insights. Data obtained from the credit network 104 includes: transaction history stored within the database of the present invention; sector and industry risk; and loan performance. Data obtained from external services 106 includes: collaborative fraud screening; ID verification; and credit risk scores.

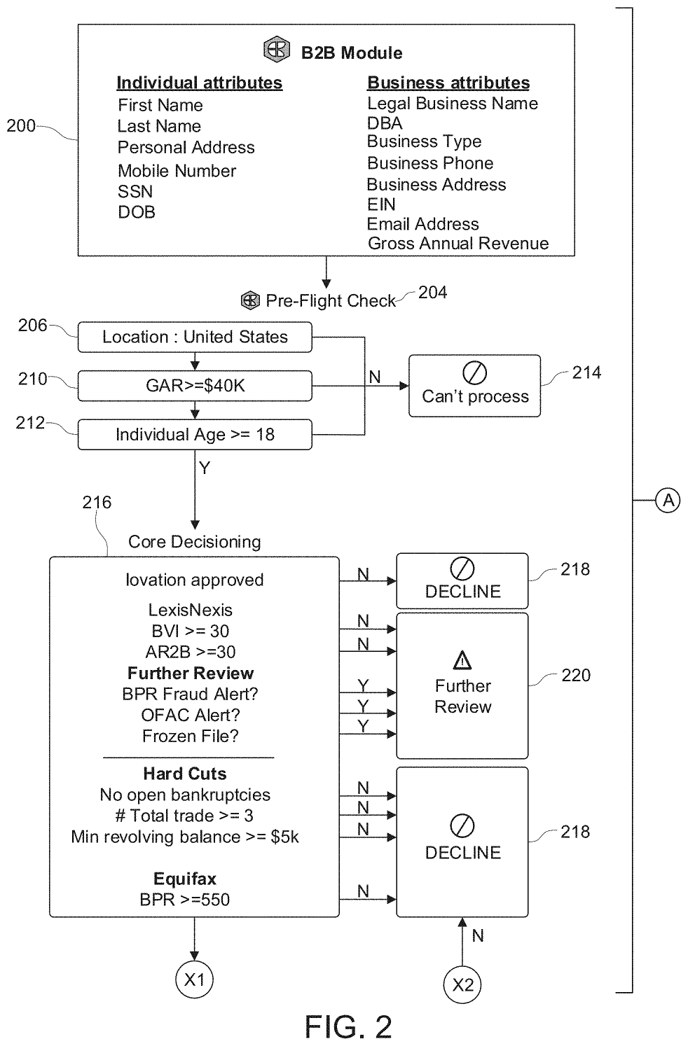

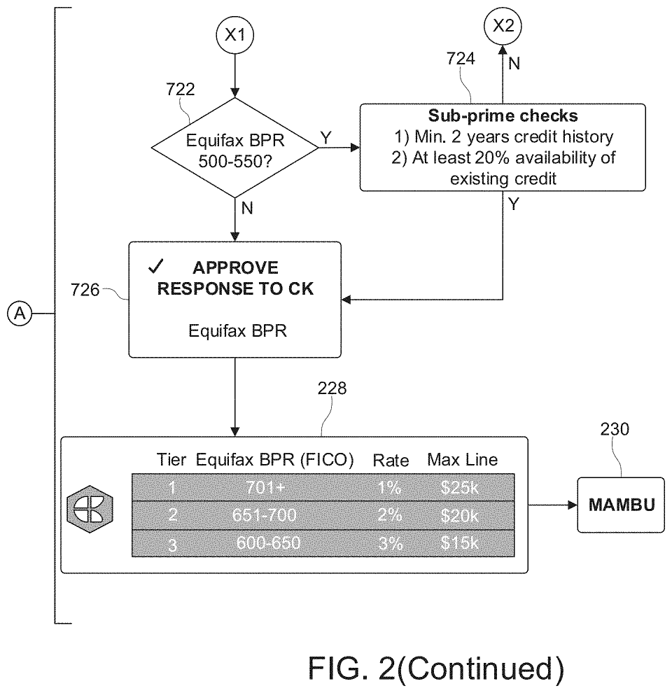

FIG. 2 is a diagram showing the underwriting process of the present invention. In accordance with the preferred embodiment of the present invention, the underwriting process processes data from the B2B module 200 of the present invention, such as data from the individual applying for credit as well as business information. This data is entered into the pre-flight check process 204 whereby it is compared with the requirements for the location 206, the Gross Annual Revenue (GAR) 210, and the age of the applicant 212. If the submitted data does not meet these requirements, the application is declined 214. If the application passes the Pre-Flight checks the application then proceeds to being processed through the Loan Origination factors in the core decision-making 216, which includes assessing factors such as: lovation approval; LexisNexis BVI and AR2B; further review that includes BPR Fraud Alerts, OFAC Alerts, and Frozen Files; Hard Cuts such as bankruptcies, number of total trades, and minimum revolving balance; and Equifax BPR. If these Loan Origination factors are not met, the application is declined 218. Alternatively, if certain criteria are in a specific threshold, the application is submitted for further review 220. Where the Equifax BPR is between 550 and 599 score 222, the application is submitted to sub-prime checks 224. Where credit history of more than two years, and 20 percent availability of existing credit exists, the application is approved 226. In addition, if the Loan Origination factors 216 are met, the application obtains an approval response from the present invention 226 and the applicant is presented with the loan information 228 including the set tier consisting of 4 different rate and maximum line of credit options based on Equifax BPR (FICO) data. This tiered rate and maximum line of credit data is then passed to a Software as a Service (SAAS) banking engine such as MAMBU 230.

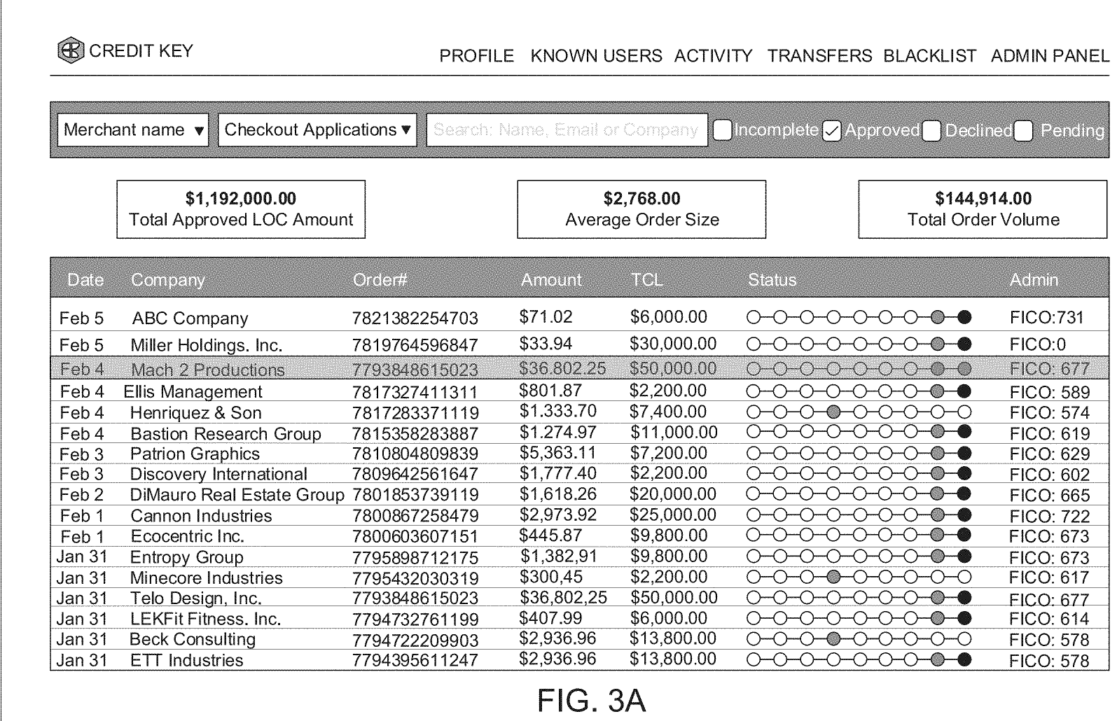

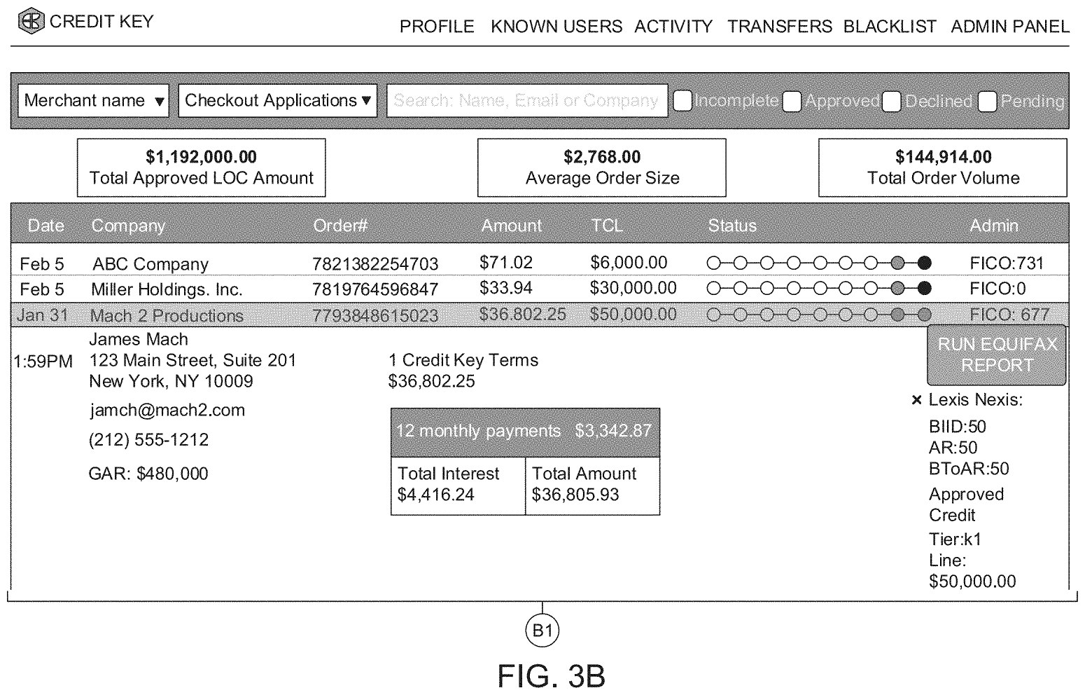

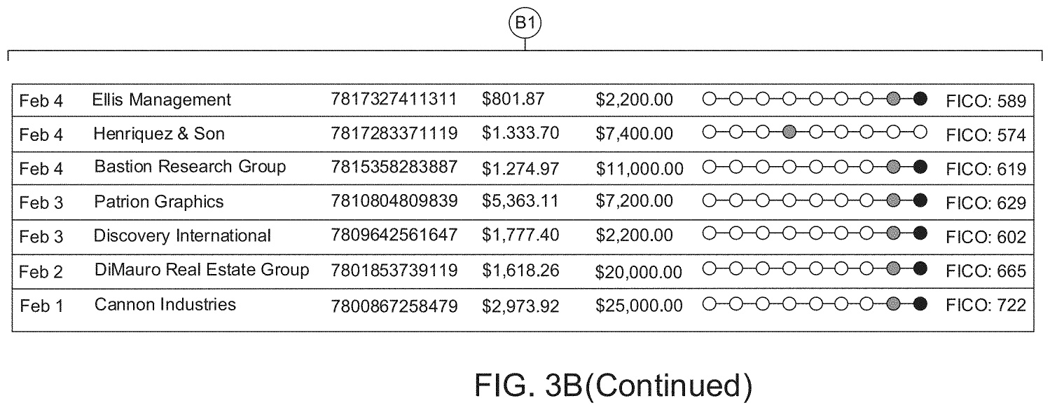

FIGS. 3A-B are diagrams of the admin portal of the present invention. In accordance with the preferred embodiment of the present invention, FIG. 3A is a rendering of the admin portal, displaying an overview of all applications and their current status of approval. FIG. 3B is a rendering of the expanded view of the admin portal, whereby the administrator can select a specific application that expands to show additional information pertaining to that specific application.

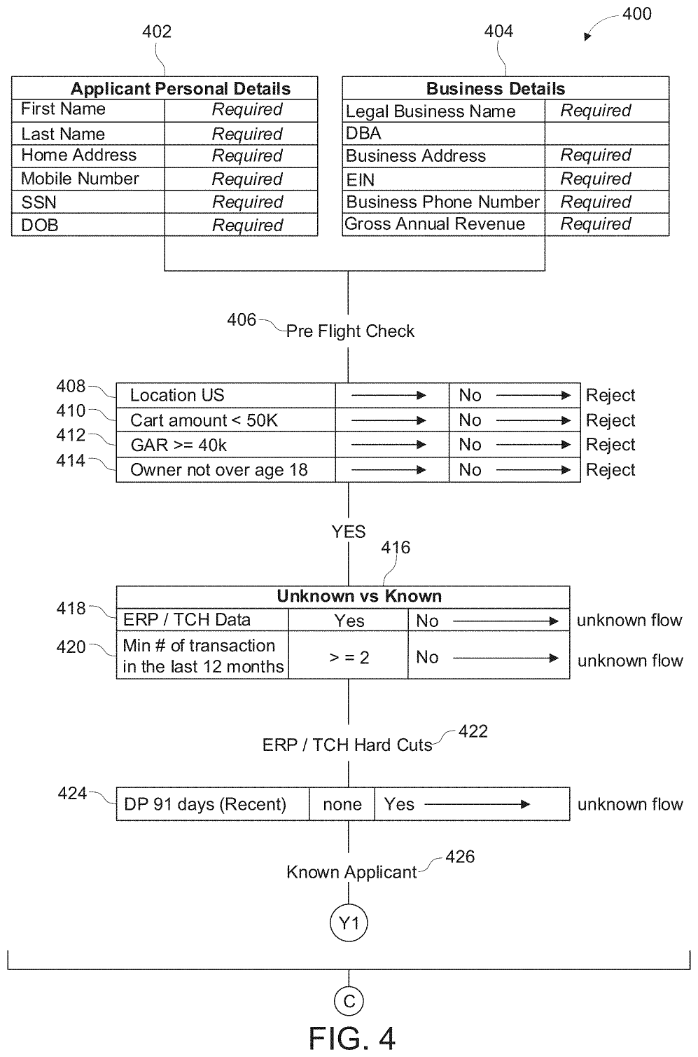

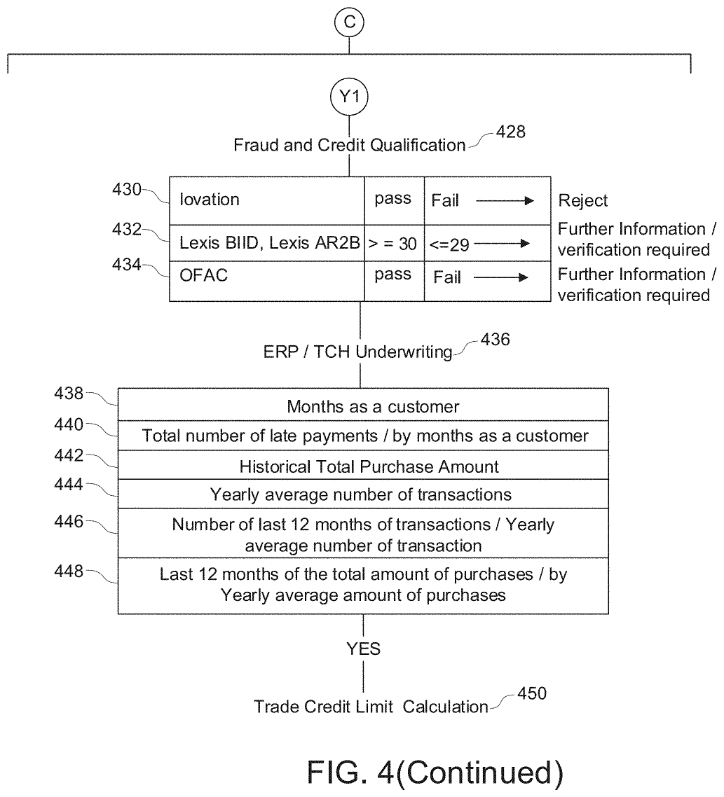

FIG. 4 is a process flow diagram of the known borrower underwriting model of the present invention. In accordance with the preferred embodiment of the present invention, the Known Borrower (ERP) underwriting model 400 requires the applicant to input personal details 402 such as: the applicant's first and last name; home address; phone number; SSN; and date of birth, as well as Business details 404, such as: the legal business name and DBA; the business address; the EIN; the business phone number; and Gross Annual Revenue (GAR). Once this information has been entered by the applicant, the data is processed through the Pre Flight Check 406. In order to proceed to the next step, the data must comply with the following parameters: the business location 408 must be located in the U.S.; the cart amount 410 must be below the threshold of $50,000.00; the GAR 412 must be within the threshold of more than $40,000.00; and the owner must be at least 18 years old 414. If the data passes these four requirements, the application proceeds to verify whether the applicant borrower is unknown or known 416. In order to qualify as a known borrower, the applicant must meet the following requirements: the applicant must have ERP/TCH data 418; the applicant must have made at least two transactions within the last 12 months 420; If the applicant satisfies these requirements, the application proceeds through to the ERP/TCH Hard Cuts verification 422, where the applicant must meet the requirement of not having had a DP credit report within the last 91 days 424. If the applicant meets this requirement, the applicant is qualified as a known applicant 426, and the application proceeds through to the fraud and credit qualification check 428. The known applicant must meet the following fraud and credit qualification 428 requirements to proceed through to the next step: the applicant must pass the lovation check 430 to confirm the applicant has a valid IP address; the applicant must have a LexisNexis Business Instant ID (BIID) and LexisNexis Business to Account Representative (AR2B) 432 score of over 30; and the applicant must pass the Office of Foreign Assets Control (OFAC) 434 qualifications set by the U.S. Treasury. If the applicant satisfies these requirements, the application proceeds to the ERP/TCH underwriting phase 436, where the following information is assessed: the amount of time in months that the applicant has been a customer 438; the amount of late payments (as a percentage) compared to the months that the applicant has been a customer 440; the applicant's total transaction volume 442; the applicant's average number of transactions per year 444; the number of purchases made in the last 12 months (as a percentage of average transactions per year) 446; and the total transaction volume of the last 12 months (as a percentage of the yearly transaction volume) 448. Once this information is reviewed and meets the requirements, the application proceeds to the final phase of the underwriting process, which is the Trade Credit Limit calculation 450.

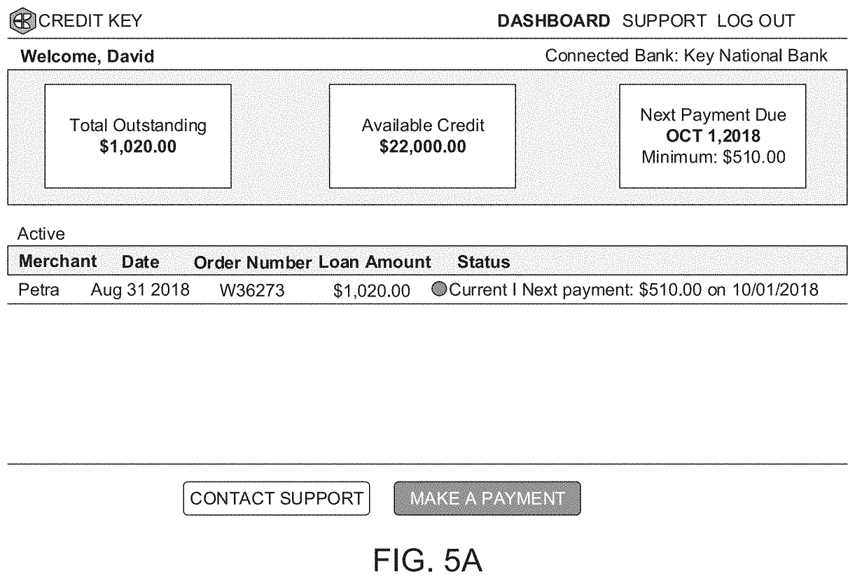

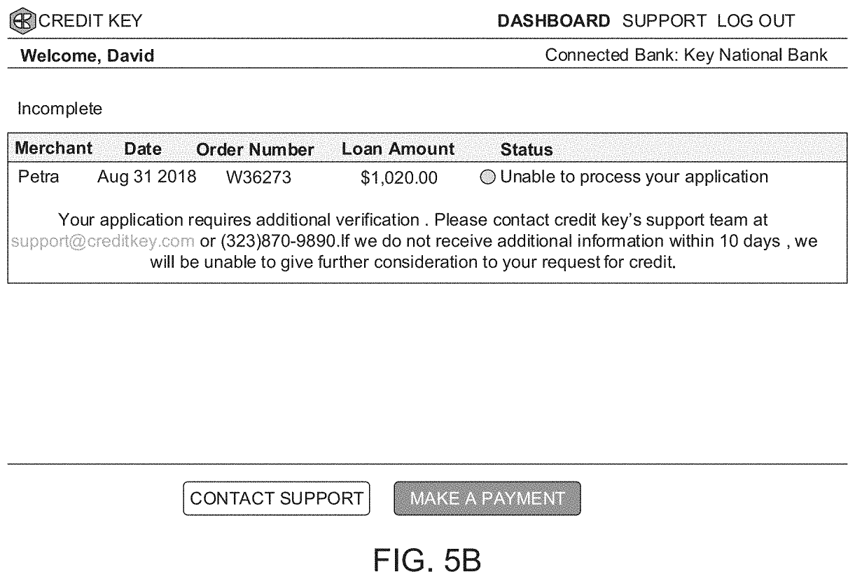

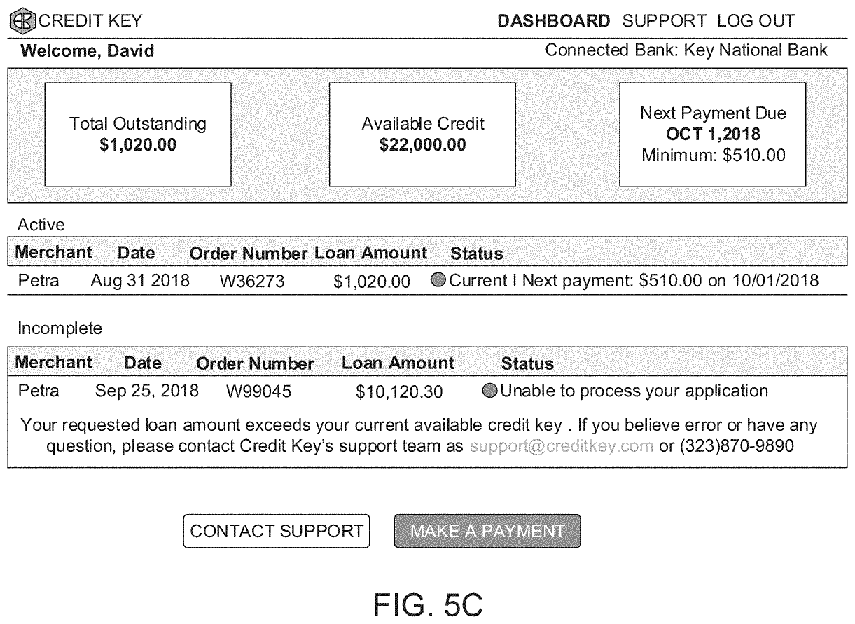

FIGS. 5A-C are diagrams of the borrower portal of the present invention. In accordance with the preferred embodiment of the present invention, FIG. 5A is a rendering of the borrower viewing screen that shows all currently active loans, including the total outstanding loan balance, the available credit, and the due date for the next payment. FIG. 5B is a rendering of the borrower portal that displays incomplete applications. FIG. 5C is a rendering of the borrower portal that displays both the currently active loans as well as incomplete applications.

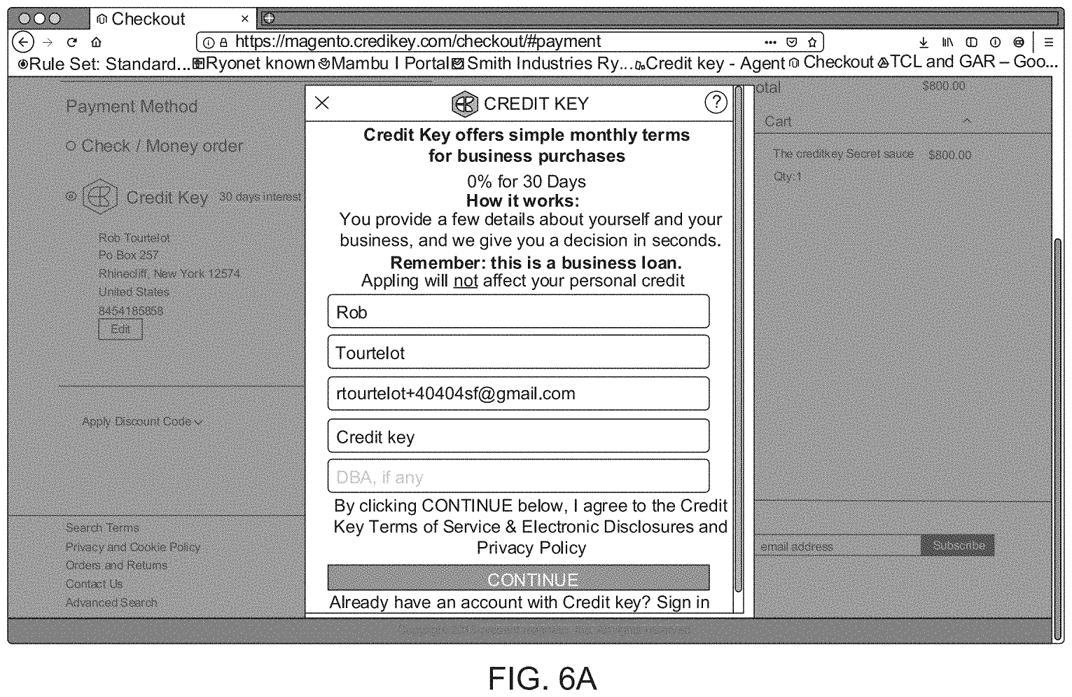

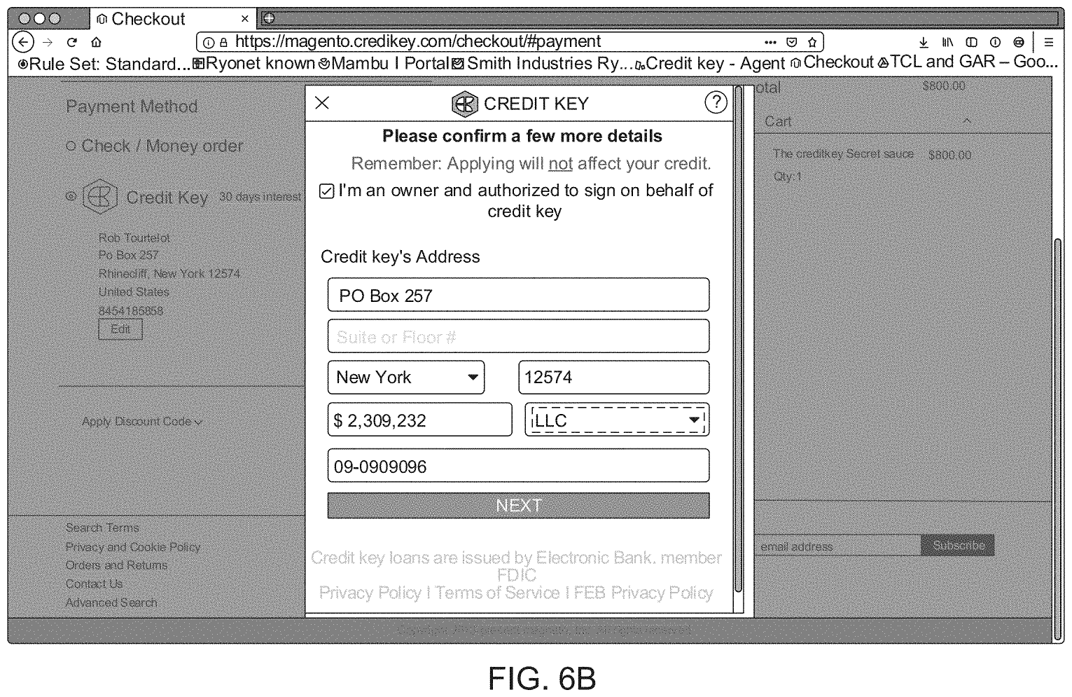

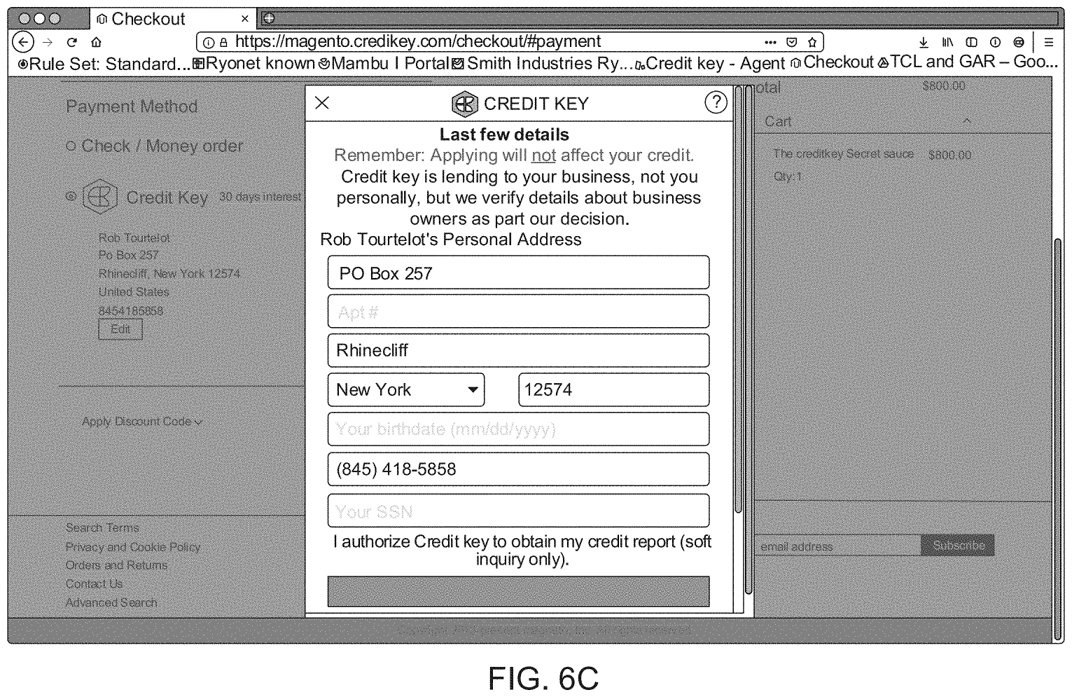

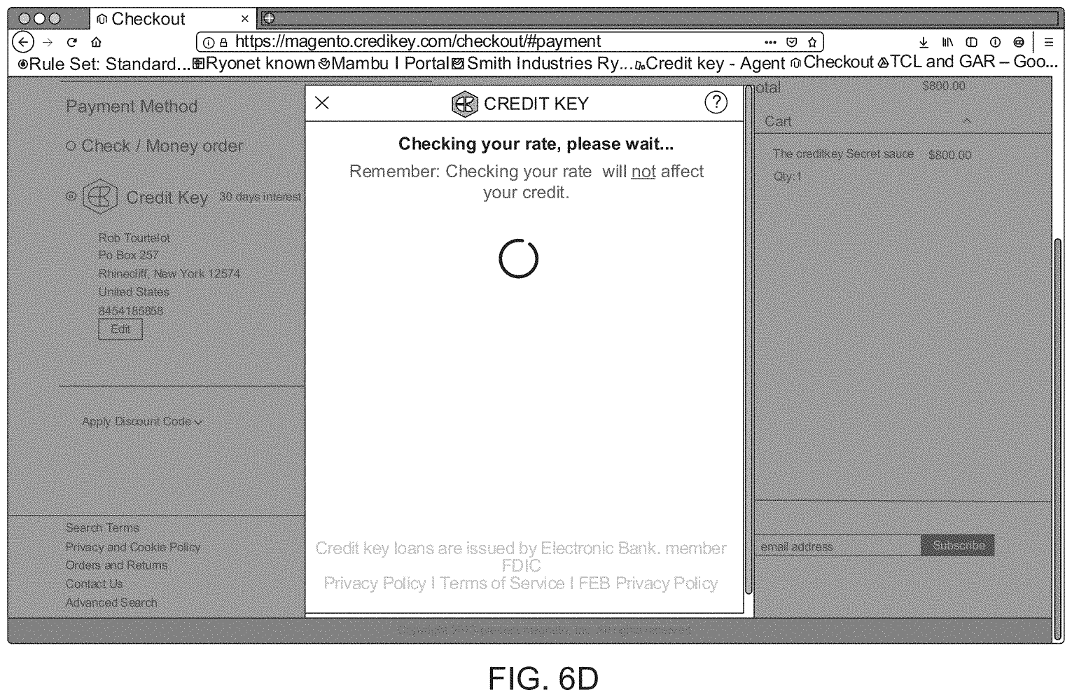

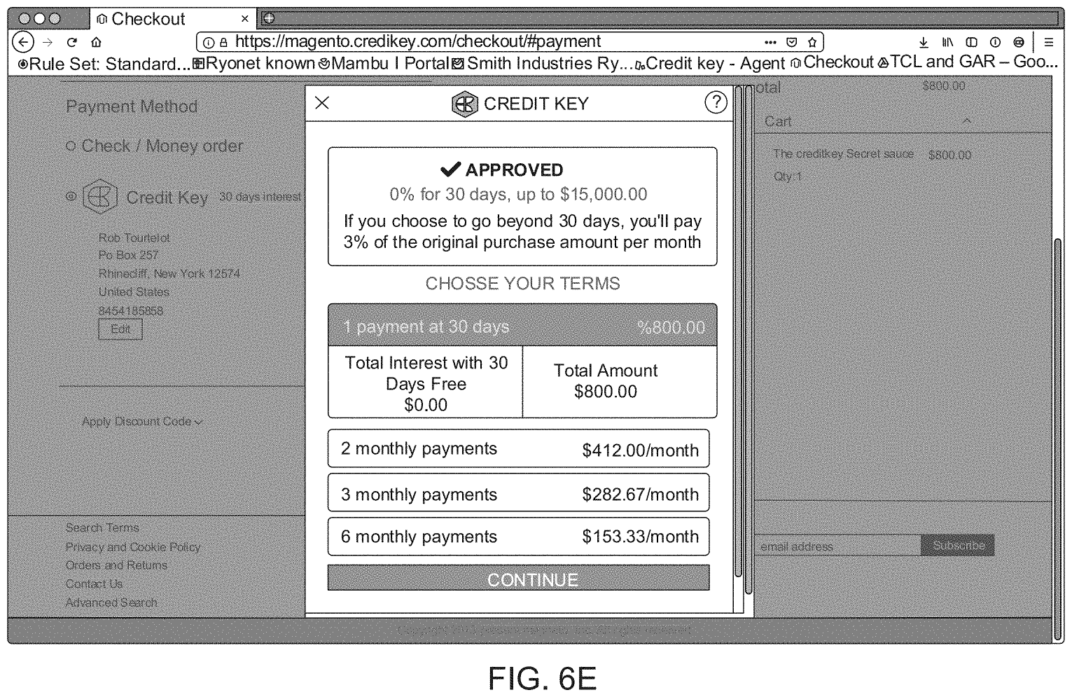

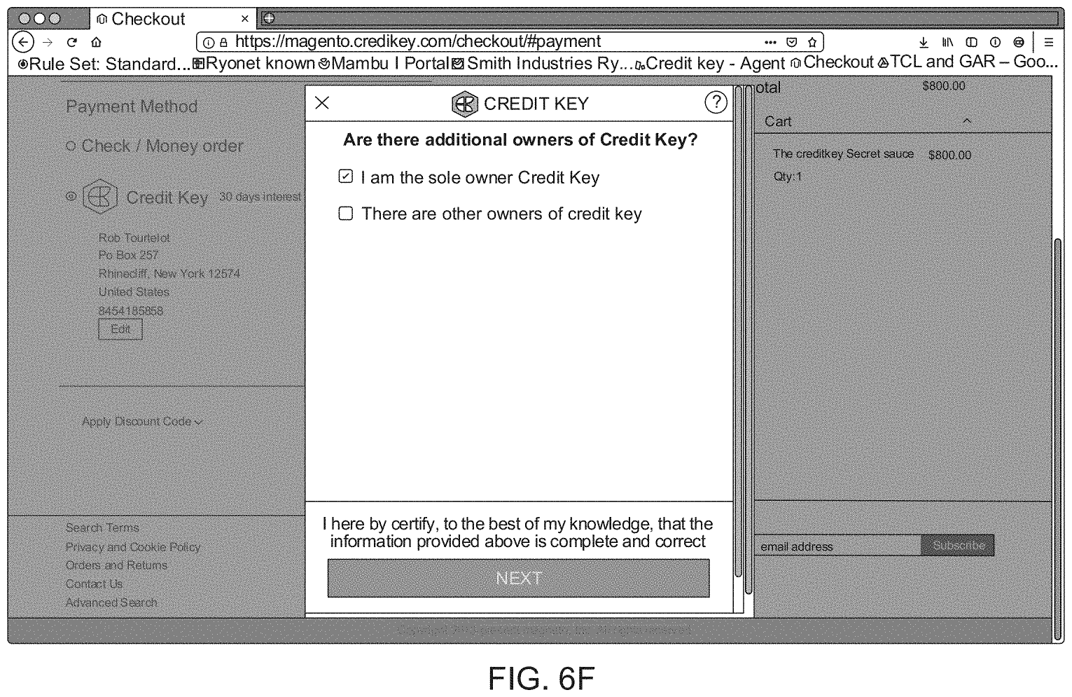

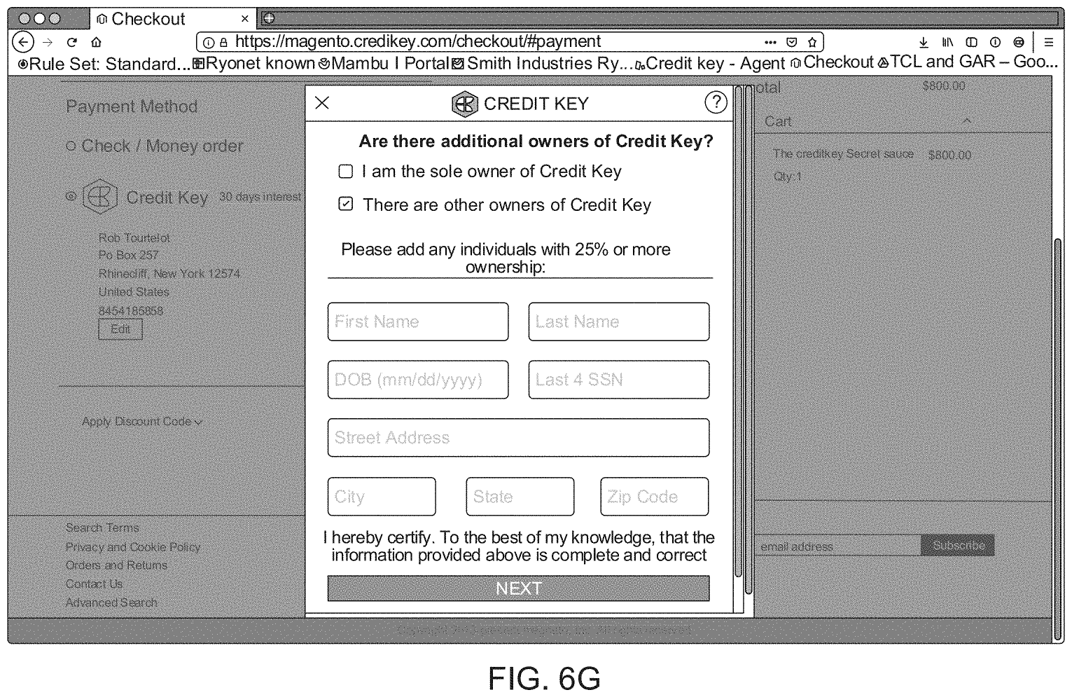

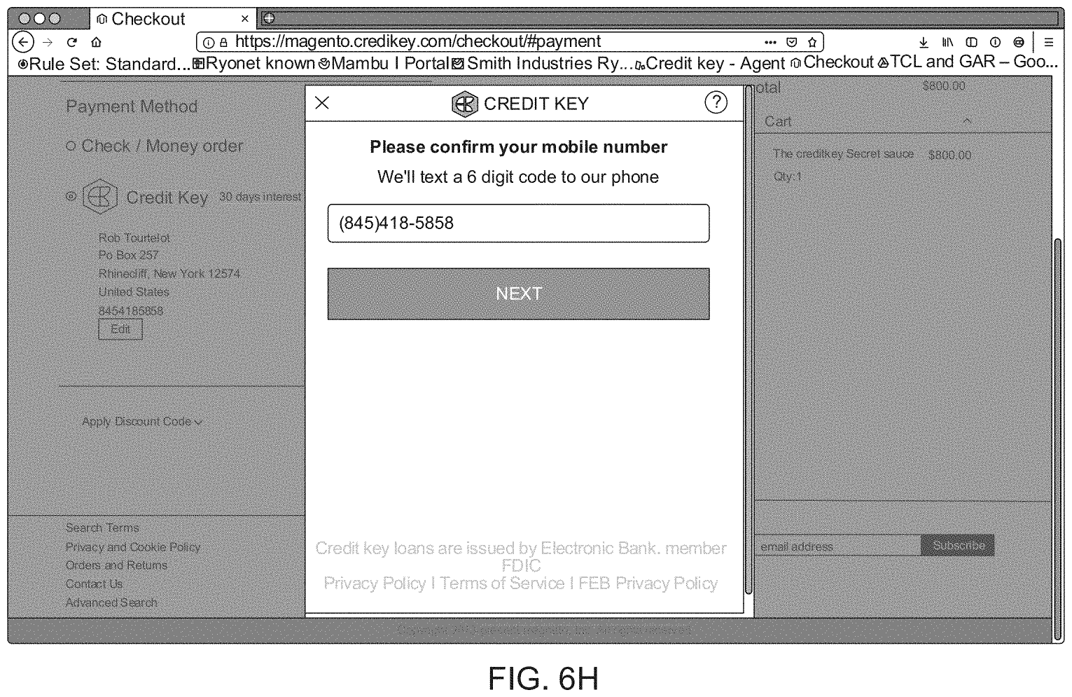

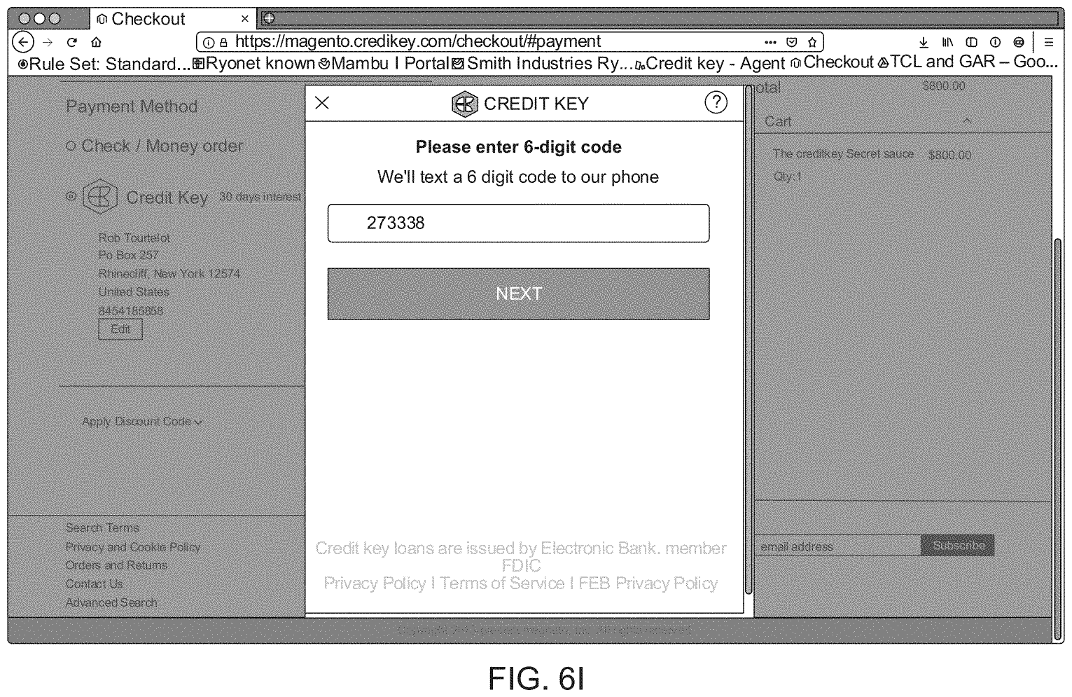

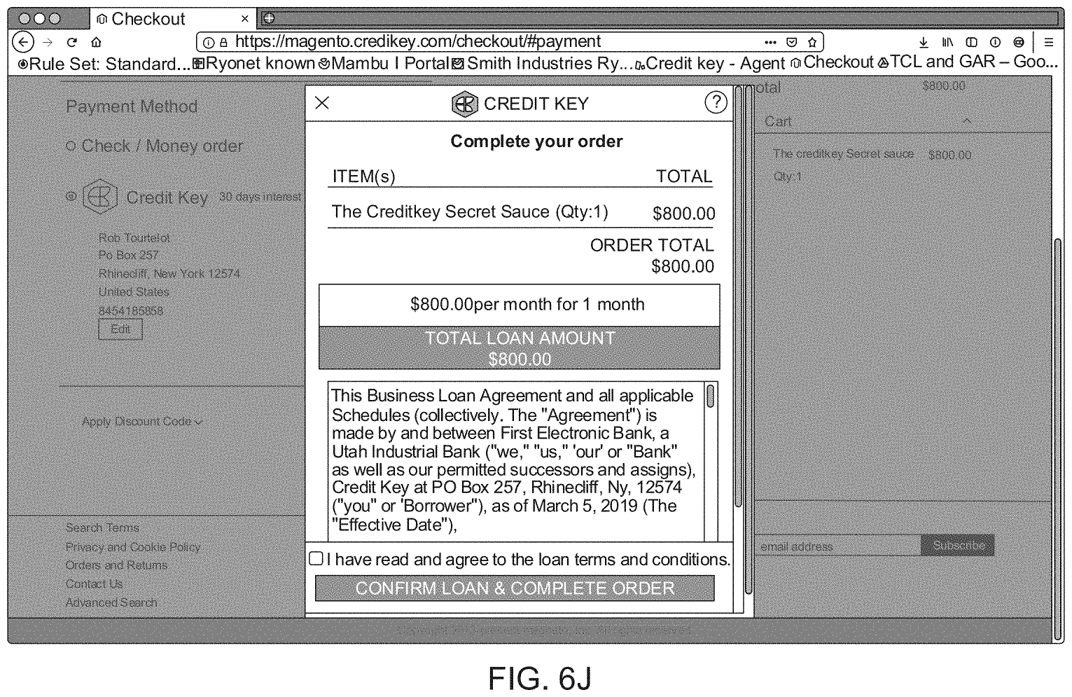

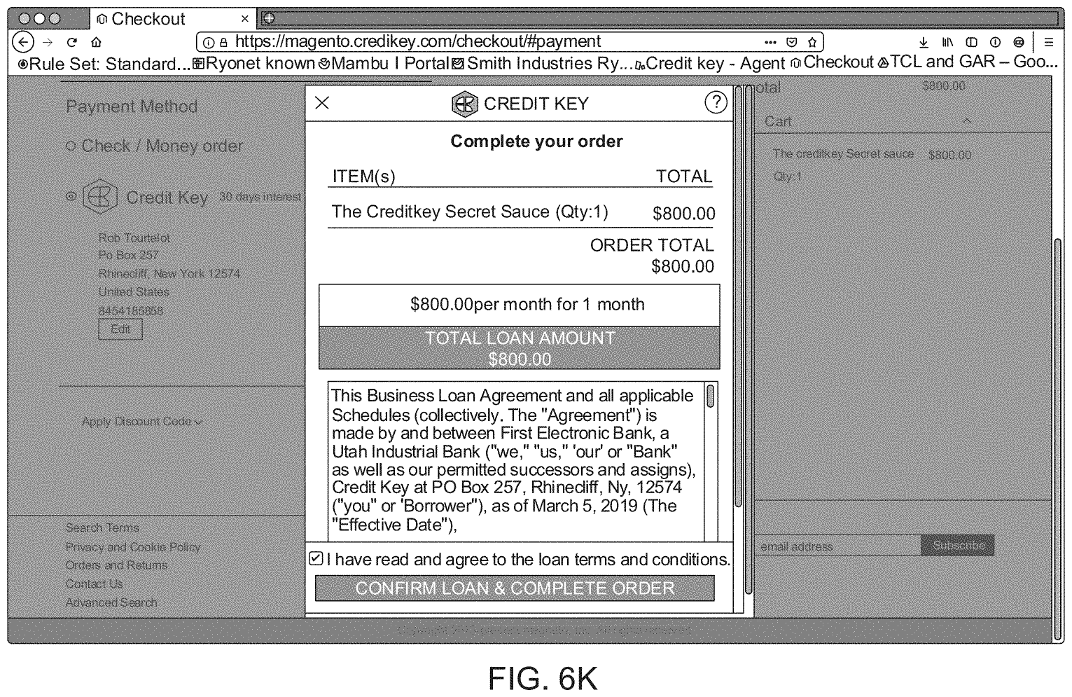

FIGS. 6A-K are diagrams showing the pre-approval flow of the present invention. In accordance with the preferred embodiment of the present invention, FIG. 6A is a rendering of the first step of the pre-approval flow process, where general information such as the borrower's full name, contact email, and business name, is entered. FIG. 6B is the next step of the pre-approval flow, where the borrower's business address details are entered. In FIG. 6C, the borrower's personal address is entered. Once the required information is entered in FIGS. 6A-C, the borrower's approval rate is calculated as shown in FIG. 6D.

FIG. 6E is a rendering of the screen that shows the loan amount the borrower is approved for, and also allows for the borrower to select the terms of payment based on monthly increments. FIG. 6F is the next step of the pre-approval application, asking if there are additional business owners of the borrower's company. FIG. 6G asks the borrower to provide the name, date of birth, SSN, and address of the additional owners. The next step, shown in FIG. 6H, asks for the borrower to confirm their mobile telephone number, in order to send out a 6-digit confirmation code. The 6-digit confirmation code sent to the borrower's mobile telephone number is entered in the screen shown in FIG. 6I. Once the borrower has been authenticated, the borrower is allowed to review their order as shown in the screen in FIG. 6J. Once the order and the terms and conditions are reviewed, the borrower acknowledges the order by indicating that they have read and agree to the terms and conditions, and the borrower can then click to confirm the loan and complete the order.

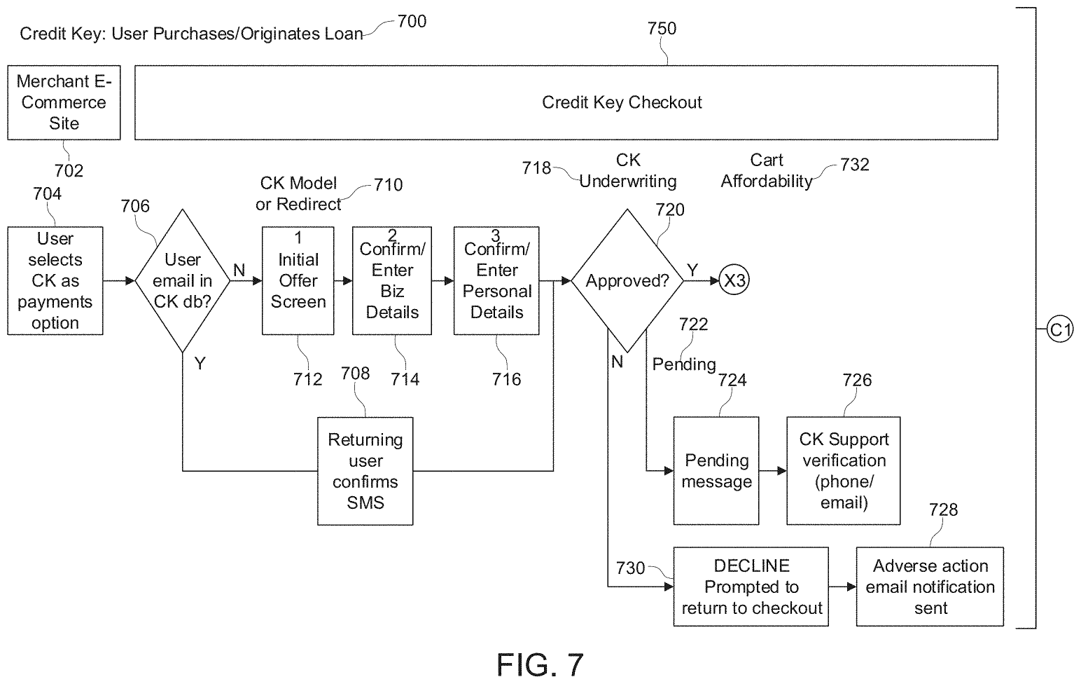

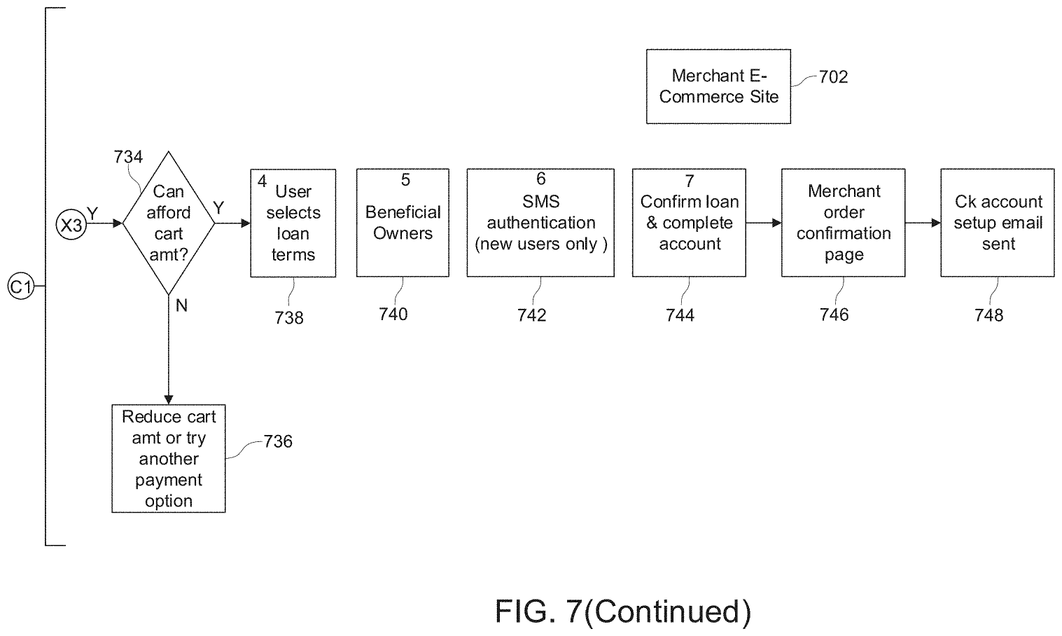

FIG. 7 is a flow diagram showing one embodiment by which a user can purchase or originate a loan and is depicted by the numeral 700. Under this embodiment, a User accesses the merchant E-Commerce site 702, and selects CK as a payment option 704. The credit key checkout platform 750 verifies whether the user email is in the credit key database 706. Where the user email address is in the database, the user is a returning user 708. If the user is not in the database, the page is redirected 710 to an initial offer screen 712. This screen allows the user to enter and confirm business details 714 and also confirm personal details 716. The personal details 716 and business details 714 are then passed to the underwriting team 718. The underwriting team determines the approval possibility 720 of the application. Where the application is not approved, it is declined and returned to checkout 730. In addition, an adverse email notification is sent 728. Where the application is in que to be reviewed, the status is labeled as pending 722 and a pending message 724 is provided to the user who will then receive an email or phone call from credit key staff 726. The next determination is regarding affordability of the items in the cart 732. A determination regarding whether the user can afford the cart amount 734 is made. If the amount is not affordable, the cart amount is reduced or the user is invited to try a different payment method 736. Where the user can afford the loan amount, the user selects the loan terms 738. Beneficial ownership terms are provided 740. For new users a text message authentication page is shown 742. The loan is confirmed and the account is completed 744. Subsequently, the merchant order confirmation page is shown 746 and the credit key account setup email is sent 748.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

Encoding the software presented herein, also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. A system for processing business to business lending opportunities, capable of communicating with at least one third party applicant device and at least one third party lender device over the internet, the system comprising:
processor;
an accessible memory unit capable of storing computer-executable instructions, which when executed by the processor, cause the system to:
transmit a user interface to the at least one third party applicant device, the user interface containing a series of inputs related to the creditworthiness of at least one business credit applicant; securely receiving responses from at least one business credit applicant via the at least one third party applicant device;
securely transmitting the responses to an underwriting engine, the underwriting engine capable of determining the creditworthiness of the at least one business credit applicant;
securely receiving the creditworthy rating from the underwriting engine; securely communicating a creditworthy rating to the at least one third party applicant device;
securely communicating the creditworthy rating to the at least one third party lender device.

2. The system of claim 1, wherein the computer-executable instructions are further capable of determining the completeness of the responses to the series of inputs and securely communicates requirements for complete responses to the at least one third party device.

3. The system of claim 1, further comprising computer executable instructions, which when executed by the process, cause the system to securely transmit the creditworthy information associated with the at least one applicant to at least one lender.

4. The system of claim 1, wherein the creditworthy is determined by a variety of factors, which when analyzed determine a risk value associated with lending to the applicant.

5. The system of claim 5, wherein the underwriting engine determines the risk value and communicates it to the at least one lending device.

6. The system of claim 1, further configured to determine the possible manner in which the at least one credit applicant can lower the lending risk.

7. The system of claim 1, further configured to communicate a risk mitigation strategy to the at least one credit applicant.

8. A method of facilitating business to business lending, the method comprising:
providing at least one business credit applicant with access to a simplified business credit application via a secure network;
receiving responses to the simplified business credit application from the at least one business credit applicant via the secure network;
assessing the creditworthiness of the at least one business credit applicant;
analyzing the lending risk associated with lending to the at least one business credit applicant based on the creditworthiness;
communicating the lending risk to at least one lender;
receiving a decision on whether to lend to the at least one business credit applicant from the at least one lender;
communicating the decision to the at least one business applicant.

9. The method of claim 8, further comprising a secure method of communicating with the at least one business credit applicant and the at least one lender.

10. The method of claim 8, further comprising determining the creditworthy of the at least one business credit applicant using predetermined factors.

11. The method of claim 8, further comprising communicating the risk value to the at least one business credit applicant.

12. The method of claim 8, further comprising instructions transmitted to the at least one business applicant to lower the risk value.

13. The method of claim 12, further comprising tracking the at least one credit applicants risk value over time.

14. The method of claim 12, further comprising risk mitigation strategies communicated to the at least one lender.

15. A system for facilitating business to business lending comprising:
a processor coupled to memory;
an operating environment executing using the processor;
an underwriting engine that is configured to determine the creditworthiness of at least one business credit applicant;
a secure network, including a platform that allows the at least one business credit applicant to provide responses to requests;
a risk assessment engine, capable of determining the risk of lending to the at least one business credit applicant and communicating said risk to at least one lender.

16. The system of claim 15, further comprising a secure method of communicating with the at least one business credit applicant and the at least one lender.

17. The system of claim 15, further capable of determining the creditworthy of the at least one business credit applicant using predetermined factors.

18. The system of claim 15, further capable of communicating the risk value to the at least one business credit applicant.

19. The system of claim 15, further capable of providing instructions to the at least one business applicant associated with risk mitigation.

20. The system of claim 15, further capable of providing instructions to the at least one business lender associated with risk mitigation.
